(19) United States
(12) Patent Application Publication
(10) Pub. No.: US 2009/0133481 A1
(43) Pub. Date: May 28, 2009

(54) SOIL MOISTURE SAMPLING DEVICE

(75) Inventor: Charles Julian Russell Baker, Wattleup (AU)

Correspondence Address: JAMES D. STEVENS;REISING, ETHINGTON, BARNES, KISSELLE, P.C., P.O. BOX 4390, TROY, MI, 48099, US

(73) Assignee: BOBTAIL TECHNOLOGIES PTY LTD, Kwinana (AU)

(21) Appl. No.: 12/275,028

(22) Filed: Nov. 20, 2008

(30) Foreign Application Priority Data
Nov. 23, 2007 (AU) 2007906404

(51) Int. Cl. G01N 5/02

(52) U.S. Cl. 73/73

(57) ABSTRACT

A soil moisture sampling device (10) arranged to be beneath a workable crop soil surface for measuring the properties of soil moisture. The soil moisture sampling device comprises a moisture collector device (12) and an instrument enclosure (14). The instrument enclosure (14) contains a tipping bucket (38) arranged to receive water from a tube (24). The tube (24) contains measuring means (34) and the tipping bucket (38) contains magnet means (40). The arrangement enables water volume to be measured by the bucket (38) tipping when one portion (44 or 46) is full.

### FIELD OF THE INVENTION

The present invention relates to a soil moisture sampling device.

### BACKGROUND TO THE INVENTION

It is known to use a set of lysimeters to monitor the quantity of water flowing through soil and to measure features of this water such as the amount of dissolved fertilizers contained therein. An apparatus and method for achieving this are described in the applicant's prior Australian Patent Application Number 20032403 12.

It has since been found that the utilisation of standard catchment vessels can lead to erroneous results under certain circumstances. There are also problems associated with tilling when utilising a rigid catchment vessel. It has also been found that the permanent wiring that is required to be installed underground is disadvantageous with regards to ongoing maintenance and corrosion.

The present invention attempts to overcome at least in part the aforementioned disadvantages of previous soil moisture sampling devices.

### SUMMARY OF THE PRESENT INVENTION

In accordance with one aspect of the present invention there is provided a soil moisture sampling device, the soil moisture sampling device comprising a moisture collector and a measuring instrument, wherein the moisture collector is arranged to receive moisture through an opening and the measuring instrument comprises a tipping bucket and a measuring device, the tipping bucket comprising at least one magnetic device arranged to generate a changing magnetic field as measured by the measuring device.

Preferably the tipping bucket comprises a first and a second magnetic device wherein the magnetic poles of the first magnetic device are aligned to be opposite relative to those of the second magnetic device.

### BRIEF DESCRIPTION OF THE DRAWINGS

The present invention will now be described, by way of example, with reference to the accompanying drawings, in which:

FIG. 1 is a schematic view of a soil moisture sampling device in accordance with the present invention; and

FIG. 2 is a front isometric view of a tipping bucket of the soil moisture sampling device of FIG. 1 in accordance with the present invention.

### DETAILED DESCRIPTION OF THE PREFERRED EMBODIMENT

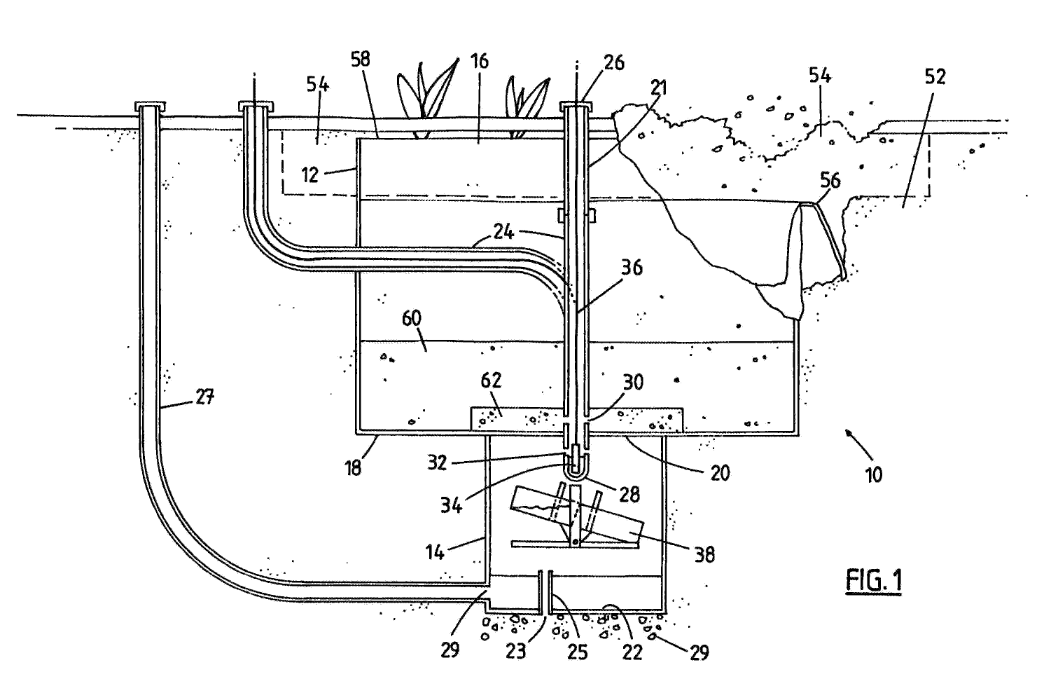

Referring to FIG. 1, there is shown a soil moisture sampling device 10. The soil moisture sampling device 10 comprises a flexible catchment vessel 12 and an instrument enclosure 14. The flexible catchment vessel 12 acts as a moisture collector.

The flexible catchment vessel 12 comprises an upper end 16 which is open and a lower end 18.

The instrument enclosure 14 comprises an upper end 20 and a lower end 22. A first end of an overflow tube 25 is inserted into an aperture 23 located in the lower end 22 of the instrument enclosure 14 such that a second end of the overflow tube 25 is located internally of the instrument enclosure 14 above the lower end 22. A first end of a sampling tube 27 is inserted into an aperture 29 located on a side wall adjacent the lower end 22 of the instrument enclosure 14. A pump (not shown) is connected to a second end of the sampling tube 27 above ground to facilitate pumping of water from the instrument enclosure 14 to the surface for chemical analysis.

The flexible catchment vessel 12 is arranged such that its lower end 18 is engaged with the upper end 20 of the instrument enclosure 14.

The soil moisture sampling device 10 further comprises a tube 24. The tube 24 extends from a first end 26 located, in use, above the upper end 16 of the flexible catchment vessel 12 to a second end 28 located within the instrument enclosure 14. The tube 24 thus passes through the lower end 18 of the flexible catchment vessel 12 and the upper end 20 of the instrument enclosure 14. An upper portion 21 of the tube 24 is removable from the tube 24. The upper portion 21 is the section of the tube 24 that would be located, in use, in a tillage zone 54. Alternatively, the tube 24 may be made of a reinforced flexible material and arranged to pass through a side wall of the flexible catchment vessel 12 at a point below the tillage zone 54. In this case, the tube 24 then rises to the surface in a region outside the tillage zone 54.

The tube 24 comprises a moisture inlet 30 and a moisture outlet 32. The moisture inlet 30 comprises at least one aperture in the tube 24 and is located, in use, in a region internal of the flexible catchment vessel 12. The moisture outlet 32 comprises at least one aperture in the tube 24 and is located, in use, in a region internal of the instrument enclosure 14.

The tube 24 is selectively open at the first end 26. The tube 24 is closed at the second end 28.

A measuring means or device 34 is arranged to be inserted into the tube 24 at the first end 26 and lowered to the second end 28. A data transfer cable 36 extends from the measuring means 34 to a data collection device (not shown). The measuring means 34 may be arranged to measure temperature, conductivity, pH level, the concentration of specific ions (for example NO₃^{-, K}⁺ and Na⁺) and magnetic fields. A tipping bucket 38 is arranged below the lower end 28 of the tube 24. The measuring device 34 and tipping bucket 38 together comprise a measuring instrument that is useful in measuring soil moisture quantities, as will be discussed further below.

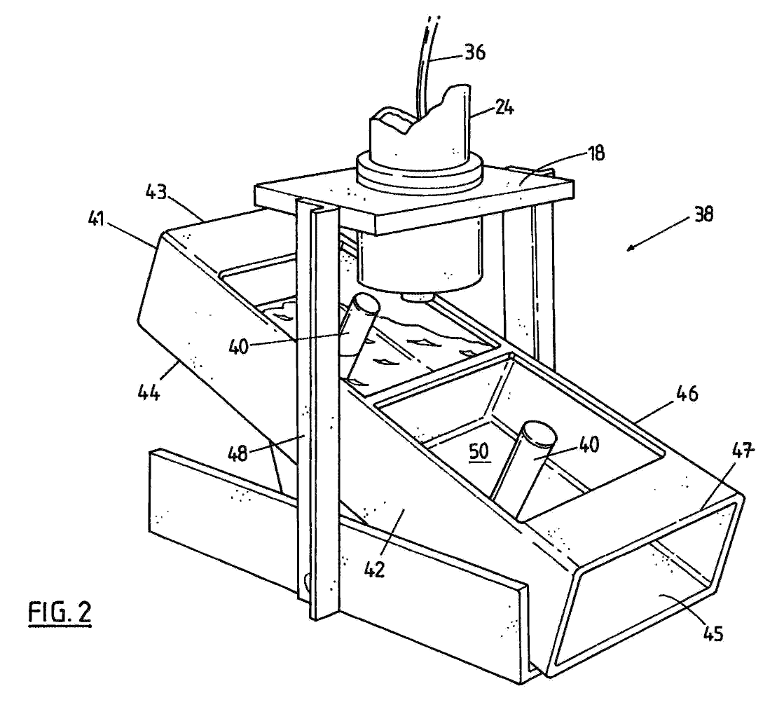

As shown in FIG. 2, the tipping bucket 38 comprises a member 42 and a plurality of magnetic means or devices 40. The member 42 comprises a first portion 44 and a second portion 46 separated by a non-apertured partition. The member 42 is arranged to rotate around a pivot (not shown) located between a support member 48 and the member 42. The first portion 44 comprises an aperture 41 located at a distal end 43. The second portion 46 comprises an aperture 45 located at a distal end 47. A respective magnetic means 40 is arranged on each of the first portion 44 and the second portion 46 of the tipping bucket 38. The magnetic means 40 may each be arranged such that their magnetic poles are substantially perpendicularly aligned relative to a lower surface 50 of the member 42. The magnetic means 40 located on the first portion 44 may be arranged such that its magnetic poles are oppositely aligned relative to the magnetic poles of the magnetic means 40 located on the second portion 46.

In use, a hole is dug in soil 52 that is to be tested (see FIG. 1). The soil moisture sampling device 10 is arranged in the hole. When in place the upper end 16 of the flexible catchment vessel 12 is located in a tillage zone 54. The flexible catchment vessel 12 may be arranged in a variety of shapes depending upon the size and shape of the hole it has been arranged in.

The flexible catchment vessel 12 can be used for a number of successive crops without having to be removed. When the soil 52 needs to be tilled, a narrow trench can be dug around the perimeter of the upper end 16 of the flexible catchment vessel 12. An upper portion 56 of the flexible catchment vessel 12 can now be arranged such that the upper portion 56 is below the tillage zone 54. The upper portion 21 of the tube 24 can also be removed from the tillage zone 54. The section of the tube 24 that remains in the soil 52 is then capped (not shown) to prevent soil and other undesirable objects and particles entering the tube 24 during tillage. After tillage the cap can be removed and the upper portion 21 reattached to the tube 24. Additionally, the narrow trench can be dug again and the upper portion 56 folded back to its original position.

The soil moisture sampling device 10 is arranged such that the tube 24 is substantially vertical with the first end 26 thereof being above an upper surface 58 of the soil 52 in which the soil moisture sampling device 10 is arranged.

The instrument enclosure 14 is arranged to be substantially empty. The tipping bucket 38 is arranged within the instrument enclosure 14 such that the tipping bucket 38 is located beneath the moisture outlet 32. Water may collect temporarily at the bottom of the instrument enclosure 14. This water may rise up to the level of the second end of the overflow tube 25 and then flow through the overflow tube 25 and out of the aperture 23. A layer of gravel or sand may be arranged below the instrument enclosure 14 to assist in dispersing the water as it flows out of the aperture 23.

The water in the instrument enclosure 14 may be pumped to the surface through the sampling tube 27 by action of the pump (not shown) so that the water may be chemically analysed, for example for concentrations of fertilisers and pesticides. In addition, if the water is pumped to the surface through the sampling tube 27 prior to water flowing out of the instrument enclosure 14 through the overflow tube 25, the amount of water can be measured to confirm the amount of water flowing through the tipping bucket 38 or to allow calibration of the tipping bucket 38. To assist in achieving full drainage of the water through the aperture 29, the lower end 22 of the instrument enclosure 14 may be angled down towards the location of the aperture 29.

When water moves downwards through the soil 52 it first passes through fine sand 60 and then through a filtering means 62 such as a water permeable sponge in the flexible catchment vessel 12. The water then enters the moisture inlet 30. The fine sand 60 and the filtering means 62 remove solid particles before the water enters the moisture inlet 30.

The water will now fill a lower region of the tube 24 where the measuring means 34 is located. The measuring means 34 measures properties of the water, for example, electrical conductivity and temperature. Water will fill the lower region of the tube 24 until the water overflows through the moisture outlet 32.

The tipping bucket 38 will receive water as it flows out of the moisture outlet 32.

Either the first portion 44 or the second portion 46 will receive water from the moisture outlet 32. The portion that receives the water is determined by which is arranged uppermost at the time. For example, if the first portion 44 is arranged uppermost as depicted in FIG. 2 then the first portion 44 will receive the water. When the first portion has received a predefined amount of water the weight force due to this water will cause the member 42 to tilt. The member 42 will tilt such that the second portion 46 is now arranged uppermost. The water that was collected in the first portion 44 will now flow out through the aperture 41 towards the lower end 22 of the instrument enclosure 14. Now that the second portion 46 is arranged uppermost, the second portion 46 will receive water from the moisture outlet 32. Once the second portion 46 has received a predefined amount of water the member 42 will tilt such that the first portion 44 is now arranged uppermost and the water collected in the second portion 46 will flow out through the aperture 45 towards the lower end 22 of the instrument enclosure 14. This process will repeat such that each time the member 42 tilts a predefined amount of water flows out of the tipping bucket 38.

The magnetic means 40 located on each of the first portion 44 and second portion 46 will create a change in the magnetic field which is detected by the measuring means 34. The measuring means 34 may comprise a device capable of measuring changes in magnetic fields, for example, a hall effect sensor. The measuring means 34 will therefore detect the change in the magnetic field from the magnetic means 40 each time the tipping bucket 38 tilts. Each time the tipping bucket 38 tilts a predefined amount of water has passed through the soil moisture sampling device 10. The total amount of water passing through the soil moisture sampling device can therefore be calculated over a period of time by multiplying the number of times the measuring means 34 detects a change in the magnetic field due to the member 42 tilting by the amount of water that flows out of either the first portion 44 or the second portion 46 each time the member 42 tilts. Data collected by the measuring means 34 is transferred to a data collection device (not shown) through the data transfer cable 36.

Modifications and variations as would be apparent to a skilled addressee are deemed to be within the scope of the present invention.

1. A soil moisture sampling device, the soil moisture sampling device comprising a moisture collector and a measuring instrument, wherein the moisture collector is arranged to receive moisture through an opening and the measuring instrument comprises a tipping bucket and a measuring device, the tipping bucket comprising at least one magnetic device arranged to generate a changing magnetic field as measured by the measuring device.

2. A soil moisture sampling device according to claim 1, wherein the tipping bucket is contained in an instrument enclosure.

3. A soil moisture sampling device according to claim 1, wherein the moisture collector is mounted above the instrument enclosure.

4. A soil moisture sampling device according to claim 3, wherein a tube passes through the moisture collector and into the instrument enclosure, the tube containing a moisture inlet and a moisture outlet, the moisture inlet being located in the moisture collector and the outlet being located in the instrument enclosure.

5. A soil moisture sampling device according to claim 4, wherein the tube contains the measuring device and means for transferring data to a collection device.

6. A soil moisture sampling device according to claim 4, wherein the tipping bucket contains a first portion and a second portion, the first and second portions being separated, the tipping bucket is located below the tube such that water from the moisture outlet of the tube passes into an uppermost portion of the tipping bucket, in use, and each portion of the tipping bucket contains respective apertures for discharging water therefrom when a predetermined amount has been collected.

7. A soil moisture sampling device according to claim 6, wherein the tipping bucket is mounted on a pivot so that as the uppermost portion receives a predetermined amount of water the tipping bucket is tilted under weight of the water so as to discharge the water from that portion and to enable the other portion to become the uppermost portion and receive water from the moisture outlet of the tube.

8. A soil moisture sampling device according to claim 6, wherein each portion contains a respective magnetic device.

9. A soil moisture sampling device according to claim 8, wherein the magnetic devices have respective poles which are disposed perpendicularly relative to a lower surface of each portion.

10. A soil moisture sampling device according to claim 9, wherein the respective poles are oppositely aligned.

11. A soil moisture sampling device according to claim 6, wherein the measuring device is capable of measuring changes in magnetic fields so as to detect magnetic field changes each time the bucket tilts.

12. A soil moisture sampling device according to claim 1, wherein the moisture collector comprises a flexible catchment vessel.

13. A soil moisture sampling device according to claim 1, wherein a sampling tube is connected to a pump means and is arranged to collect water from the sampling device for sampling or calibration purposes.
